(19) United States
(12) Patent Application Publication
(10) Pub. No.: US 2016/0089608 A1
(43) Pub. Date: Mar. 31, 2016

(54) COMPUTER-IMPLEMENTED METHOD FOR DETERMINING GAME MECHANICS IN BUSINESS PROCESS GAMIFICATION

(71) Applicant: International Business Machines Corporation, Armonk, NY (US)

(72) Inventors: Vincent Yw Deng, Taipei (TW); Pao-Chuan Liao, Taipei (TW); Raymund June-Ray Lin, Taipei (TW); Binh Q. Nguyen, Research Triangle Park, NC (US)

(21) Appl. No.: 14/868,536

(22) Filed: Sep. 29, 2015

(30) Foreign Application Priority Data
Sep. 30, 2014 (TW) 103134136

(51) Int. Cl. A63F 13/79

(52) U.S. Cl. CPC A63F 13/79

(57) ABSTRACT

Aspects are related to automatically determining game mechanics in business process gamification. Execution data of prior users of a first task in a business process is accessed in a history database. The execution data of the prior users of the first task is analyzed. The game mechanics for the first task is determined according to a result of the analyzing.

### FOREIGN PRIORITY

This application claims priority to Taiwan Patent Application 103134136, filed 30 Sep. 2014, and all the benefits accruing therefrom under 35 U.S.C. §119, the contents of which in its entirety are herein incorporated by reference.

### BACKGROUND

Embodiments of the present invention relate to computers, and more specifically, to a computer implemented method for automatically determining game mechanics in business process gamification.

### SUMMARY

Embodiments include methods, systems, and computer program products for automatically determining game mechanics in business process gamification. Execution data of prior users of a first task in a business process is accessed in a history database. The execution data of the prior users of the first task is analyzed. The game mechanics for the first task are determined according to a result of the analyzing.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computer system in accordance with an embodiment;

FIG. 2 is a flowchart of a method in accordance with an embodiment;

FIG. 3 is a flowchart of a method in accordance with an embodiment;

FIG. 4 is a flowchart of a method in accordance with an embodiment; and

FIG. 5 is a hardware environment block diagram of a computer device in accordance with an embodiment.

### DETAILED DESCRIPTION

The term “gamification” as used herein refers to the usage of game elements and game design techniques in non-game contexts. A goal of gamification is to apply the appealing factors of games in non-game contexts to motivate users to achieve certain goals and keep their attention during the process. In conventional technology, the concept of gamification has been introduced into digitalized business process management to increase efficiency.

An aspect of an embodiment of the present invention provides a computer implemented method for automatically determining game mechanics in business process gamification; more particularly, the method of embodiments of the present invention may be implemented without affecting or interrupting the original business process. A challenge in business process gamification is how suitable game mechanics corresponding to business process characteristics may be determined, such as the selection and combination of game elements of points, achievement/badges, level, leader board, rewards, etc. Embodiments described herein provide a method for automatically recommending suitable game mechanics.

Contemporary approaches to game mechanics can simply determine a score according to time spent to finish a certain business process task. When the finishing of the task involves quality or communication and collaboration with others, these game mechanics don't work.

Tasks in business processes are numerous and diversified and if every task is gamified and game mechanics are chosen by manual design, the cost will be overly high and not feasible. With the lack of suitable game mechanics, business process gamification remains at the concept level.

In view of the above, embodiments of the present invention provide a computer implemented method for automatically determining game mechanics in business process gamification, including: accessing, from a history database, execution data of prior users of a first task in a business process; analyzing the execution data of the prior users of the first task; and determining game mechanics for the first task according to a result of the analyzing.

Embodiments of the present invention can also provide a computer implemented method for automatically determining game mechanics in business process gamification, including: accessing task data of a task assigned to a user or a set of users when the user or the set of users are required to finish the task in a business process; analyzing the task data of the task assigned to the user or the set of users; and determining game mechanics for the task and selecting a game element adopted by the game mechanics according to an analysis result.

Other embodiments provide computer program products, stored on computer-readable mediums and including computer-readable programs to be executed on a computer device to implement the methods described herein.

Other embodiments include a computer system that includes an appliance that includes a bus system, a memory, and a processing unit, where the memory saves a set of computer-executable instructions and the processing unit executes the set of computer-executable instructions to implement the methods described herein.

Reference throughout this specification to features, advantages, or similar language does not imply that all of the features and advantages that may be realized with embodiments of the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of embodiments of the invention may be combined in any suitable manner in one or more embodiments. One skilled in the relevant art will recognize that embodiments of the invention may be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, embodiments of the present invention may be embodied as a computer system/device, a method or a computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN) or a wide area network (WAN), or the connection may be made to an external computer (for example, through the Internet using an Internet Service Provider).

Embodiments of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

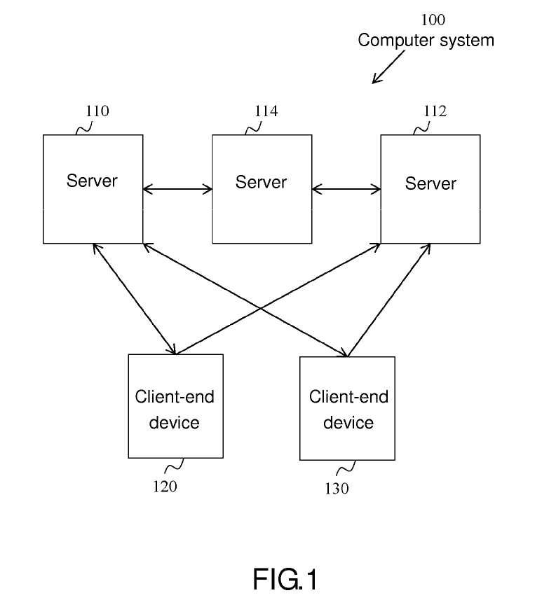

Referring now to FIG. 1 through FIG. 5, computer systems/devices, methods, and computer program products are illustrated as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 1 shows a schematic of a system architecture 100 according to an embodiment of the invention, which is only for those skilled in the art to understand the invention more clearly and not for limiting embodiments of the invention. A computer system 100 in an embodiment, for example, comprises servers 110, 112, and 114 that may communicate with each other via networks (not shown).

In this embodiment, the server 110 serves as a business process management engine and the server 112 serves as a gamification engine. The server 110 is used for managing business processes of a company or other organizations, and users (such as employees) may connect to and log in the server 110 to execute required tasks via networks (not shown) by client-end devices 120 and 130 (such as personal computers, notebook computers, mobile electronic devices, or smart TV). The server 110 may further record historical execution data of each task in each business process, i.e., historical data of tasks executed by all users in the company via the server 110, which may be saved at a database (not shown) in the form of log files.

The server 112 (gamification engine) applies predetermined game mechanics in the business processes managed by the server 110. The Business Process Manager, a product of IBM®, may serve as further reference for business process management engines. The SAP Gamification Platform, a product of SAP®, may further serve as reference for gamification engines.

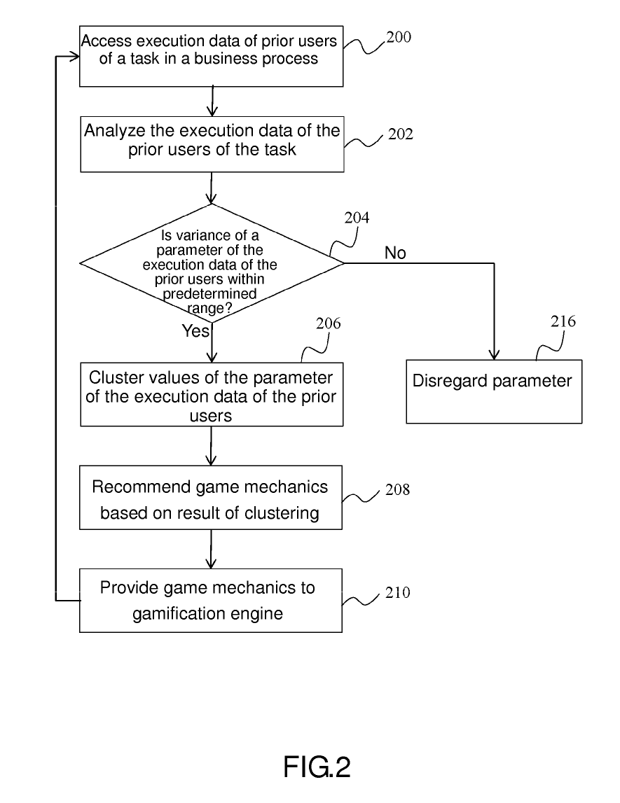

More particularly, the server 114 carries out the methods shown in FIG. 2 to FIG. 4; the server 114 performs the function of determining or recommending the game mechanics. The details shall be described with reference to subsequent flowcharts.

Preferably, the server 114 communicates with and is connected to the servers 110 and 112, and needs not to directly connect with one or more client-end devices 120 and 130; however, embodiments of the invention are not limited thereto. In addition, it should be noted that, although FIG. 1 shows the servers 110, 112, and 114 as three independent servers, it is understood that the servers 110, 112, and 114 may be integrated into a single server. In another embodiment, the servers 110, 112, and 114 may also be implemented in a cloud-computing environment.

According to an embodiment of the present invention, the client-end computers 120 and 130 are electronic products for executing applications to provide an instant message, an e-mail, or a short message, or electronic products for executing other applications to dispatch information, such as desktop computers, notebook computers, terminal apparatuses, mobile phones, or personal digital assistants. The client-end computers can also execute applications like word processing services or browsers. In an exemplary embodiment, the client-end computer is a general desktop computer including: a processor for executing various applications; a storing device for storing various information and program codes; a display device; a communication and output/input device for use as an interface for communication with the users; and peripheral elements or other elements with specific purposes. Other embodiments of the present invention may also be implemented in other manners and thus require more other devices/elements or less other devices/elements.

Likewise, the servers 110, 112, and 114 can come in the form of a general computer, a computer with a special purpose, a high-level workstation, or a large host computer as needed, without affecting the implementation of embodiments of the present invention. The required network can also come in a connection of any type, including a wide area network (WAN) or a local area network (LAN) with static IP, or a temporary connection to the Internet through an Internet service provider (ISP), whether by cable connection or by wireless connection. Persons skilled in the art are able to understand that the network can also have other hardware and software elements (such as an additional computer system, a router, or a firewall) not shown in the accompanying drawings.

Each of the client-end computers for executing various applications (such as an instant message system, an e-mail system, or a short message system) for dispatching information includes an information plug-in and thus can interact with the servers 110, 112, and 114.

It should be noted that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Embodiments of the present invention are hereunder illustrated with several simplified embodiments. As mentioned earlier, persons skilled in the art should understand that embodiments of the present invention are not limited to the embodiments below.

<Method Flow>

FIG. 2 shows a flowchart of an embodiment of the invention, in which the server 114 as shown in FIG. 1 performs a computer implemented method of determining or recommending game mechanics.

Block 200: the server 114 communicates with the server 110 serving as the business process management engine to access, for example, a log file of a specific task in a business process. If the log has a large number of files, the server 114 may provide a screening condition, such as only requiring the server 110 to provide log files of the past three years. In this embodiment, the specific task in the business process may be, for example, approving requests of leave of subordinates.

Block 202: the server 114 analyzes, for example, the statistics of times spent to finish the specific task from the log files provided by the server 110, such as calculating the average, standard deviation, and variance of times spent by the prior users. In addition to using spent times as a parameter, the server 114 may also analyze other parameters of the log files, such as counts of a predetermined operation (such as printing documents or sending emails) executed by the users to finish the specific task.

Block 204: to determine whether it is proper to determine or recommend game mechanics basing on the times spent to finish the specific task, the server 114 may determine whether the variance of the times spent by the prior users is within a predetermined range. If the variance is too small, the room for improvement of the users by motivation is limited; if the variance is too large, the specific task may have factors that are not controllable to the users themselves; therefore, the expected effect may not be achieved if it is still attempted to motivate the users by gamification.

Block 204: if the result of determination is affirmative, the flow proceeds to block 206; if not, then the variance of the parameter is too large or too small, and the flow proceeds to block 216 and the parameter is disregarded; in other words, the specific task is not gamified according to this parameter. In other embodiments, in addition to variance, other statistic data measures such as standard deviation, average, and their combination may also be used to determine whether a certain parameter of the specific task may be considered when determining or recommending game mechanics.

Block 206: in this block the server 114 clusters the times spent by the prior users; in this embodiment, the server 114 uses, for example, centroid-based clustering as the clustering algorithm, while other clustering algorithms may also be used and embodiments of the present the invention are not limited thereto. The number of cluster may be determined in advance or according to a result of the clustering algorithm. For the purpose of illustrating an embodiment of the invention, the server 114 may be assumed to have clustered the times spent by 1000 prior users to finish the specific task into the following 3 groups (G1-G3) in block 206:

(G1): more than 48 hours (200 users);

(G2): 12 to 48 hours (750 users);

(G3): less than 12 hours (50 users).

Block 208: in this block, the server 114 recommends the following two game mechanics M1 and M2 for the specific task based on a result of the clustering in above:

(M1): reward X points for finishing in 48 hours;

(M2): reward 4X points for finishing in 12 hours.

In this embodiment, the recommended game mechanics M1 and M2 in block 208 are based on an analysis result of the data of the prior users in block 206. For instance, the number of the game mechanics M1 and M2 corresponds to the groups G2 and G3 with room for improvement (compared with group G1) in the result of the clustering; the game mechanics M1 and M2 adopt the game element of “challenge” with time limits, and use the time limits of the groups G1 and G2 as parameters of the challenge to motivate users to achieve performances of the group G2 or, even better, the group G1. By recommending game mechanics according to historical data of the prior users, game mechanics with reasonable challenge may be designed, and game mechanics that are too easy or too difficult which are boring or frustrating to the users may be avoided.

On the other hand, the design of the rewards in the game mechanics M1 and M2 is also related to the analysis result in block 206; more particularly, the design of the reward should correspond to the challenge of the game. Therefore, in this embodiment, the time limit of the group G1 is one fourth that of the group G2, for example, and thus the reward in the game mechanics M1 is designed to be four times the reward in the game mechanics M2 to reflect the correspondence between the reward and the challenge.

Block 210: in this embodiment, to comply with company regulations, the server 114 may submit the two recommended game mechanics M1 and M2 to a manager (such a manager of Human Resources Department) for approval. After approval by the manager, the server 114 may activate the game mechanics M1 and M2 and transmit the game mechanics M1 and M2 to the server 112 serving as the gamification engine. Subsequently, when a user or a set of users are required to finish the specific task, the server 112 serving as the gamification engine may present the game mechanics M1 and M2 to the user and handle subsequent gamification operations such as recording gamification data, maintaining a leader board, etc.

It is worthy to note that, the blocks 200 to 210 may be repeated; in other words, every time block 200 is performed, the server 110 serving as the business process management engine provides the latest log file of the specific task, and thus the game elements and parameters of the game mechanics recommended in block 208 every time may change dynamically and are not fixed. In other words, when the same user performs the same specific task next time (e.g., approving requests of leave of subordinates), updated game mechanics may be received and the appeal of the game to the user may be enhanced. In one embodiment, the latest log file of the specific task may even cause the result of determination in block 204 to be No, and thus the specific task is no longer gamified (block 216); in other words, when the same user performs the same specific task next time, no games will be provided to this user.

In an alternative embodiment, in block 200, the server 114 may additionally access log files of other tasks in the same business process, and perform correlation analysis of execution status of the specific task by the prior users and execution status of other tasks in the same business process by the prior users, so as to determine, for instance, whether executing the specific task under particular conditions is particularly beneficial (or unbeneficial) to the execution efficiency of other tasks or the entire business process. In another alternative embodiment, in block 200, the server 114 may only access log files of other tasks in the same business process and not the log files of the specific task to perform the above determination. For instance, if the analysis shows that it will be beneficial to the execution of subsequent tasks if the specific task is finished between 9 am and 11 am every day, the server 114 may additionally recommend to adopt a game mechanics M3 with a game element of “achievement/badges” in block 208:

(M3): additionally grant an “Excellent” badge for finishing between 9 am and 11 am every day.

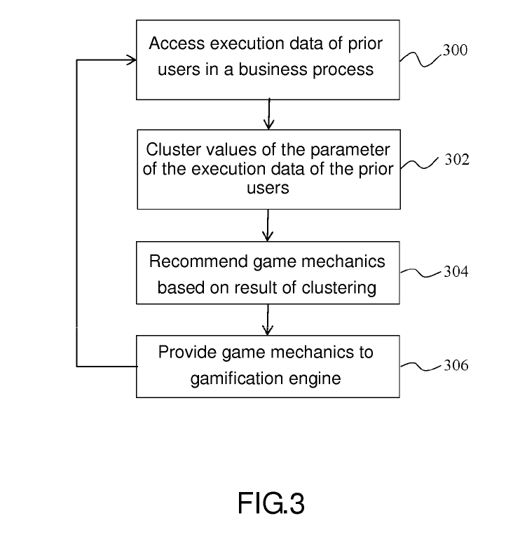

FIG. 3 shows a flowchart of another embodiment of the invention, in which the server 114 in FIG. 1 performs a computer implemented method of determining or recommending game mechanics. Compared with the embodiment of FIG. 2 which recommends game mechanics intending to reduce idle times to enhance work efficiency, the embodiment of FIG. 3 recommends game mechanics intending to encourage users to increase counts of an operation/action determined to be beneficial in advance as many as possible, such as seeking advice from or giving feedback to colleagues on a platform provided by the server 110.

Block 300: this block is generally the same as block 200 in FIG. 2. The server 114 communicates with the server 110 to access historical records of users of each department of the company collaborating via the server 110 (i.e., seeking advice from or giving feedback to colleagues). More particularly, in this embodiment, the server 114 may only access historical collaboration records of each department pertaining to the specific task, or may access all historical collaboration records of each department within a given period (such as three years) not limited to a specific task.

Block 302: the server 114 analyzes, for example, the statistics of counts of collaboration of departments from the historical records provided by the server 110. Preferably, since the number of employees and job contents of each department are different, the counts of collaboration may be normalized, or a collaboration factor may be calculated according to predetermined rules and the statistics thereof may be analyzed accordingly. For example, the collaboration factor may be designed to be the counts of collaboration divided by the number of department employees, yet it is understood that the collaboration factor may be adjusted according to actual situations and embodiments of the invention are not limited thereto. Subsequently, the server 114 clusters the collaboration factors of the departments; block 206 in FIG. 2 provides the details.

Block 304: in this block, the server 114 recommends one or more game mechanics based on a result of the clustering in block 302; block 208 in FIG. 2 provides the details. More particularly, compared with block 208 which adopts the game element of “challenge” with time limits, this block adopts the game element of “mission” which has no time limits, especially considering the fact that one is generally less intended to collaborate with others when there are time limits.

Block 306: the server 114 transmits the recommended game mechanics to the server 112 serving as the gamification engine; block 210 in FIG. 2 provides the details.

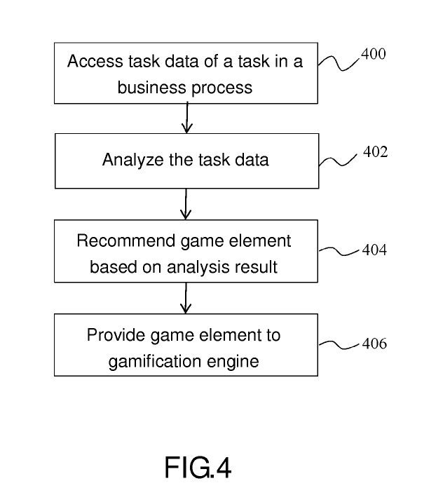

FIG. 4 shows a flowchart of another embodiment of the invention, in which the server 114 in FIG. 1 performs a computer implemented method of determining or recommending game mechanics. Compared with the embodiment of FIG. 2 which is based on historical data of the prior users, the embodiment of FIG. 4 is based on task data provided to a user when performing the task; in other words, the game mechanics, and particularly the selection of proper game elements, are recommended based on the contents of the task. However, it should be noted that the embodiments in FIG. 4 and FIG. 2 are not mutually exclusive; on the contrary, the embodiments in FIG. 4 and FIG. 2 may be combined and implemented together.

Block 400: when a user or a set of users (such as a department) are required to finish a task in a business process, the server 114 communicates with the server 110 to access task data of the task, wherein the task data is data to be studied by the user to finish the task. For instance, when the task is replying a customer complaint, the task data is the email sent from the customer.

Block 402: the server 114 analyzes the task data. For the example of the task data being the email sent from the customer, the server 114 may determine whether the customer is a VIP customer from the email address of the customer, or determine the category of the customer complaint from the title of the customer email.

Block 404: in this block, the server 114 recommends one or more game mechanics based on a result of the analysis in block 402. For example, when the result of the analysis indicates that the customer is a VIP customer, it is recommended to adopt a game mechanics M4 with the game element of “challenge” with time limits:

(M4): reward X points for replying in 24 hours.

On the other hand, when the result of the analysis indicates that the customer complaint is related to a specific product, it may be additionally recommended to adopt a game mechanics M5 with the game element of “mission” which has no time limits:

(M5): additionally reward 0.2X points for reporting the customer complaint to the product manager in charge of the product and following up the feedback.

Block 406: the server 114 transmits the recommended game mechanics to the server 112 serving as the gamification engine; block 210 in FIG. 2 provides the details.

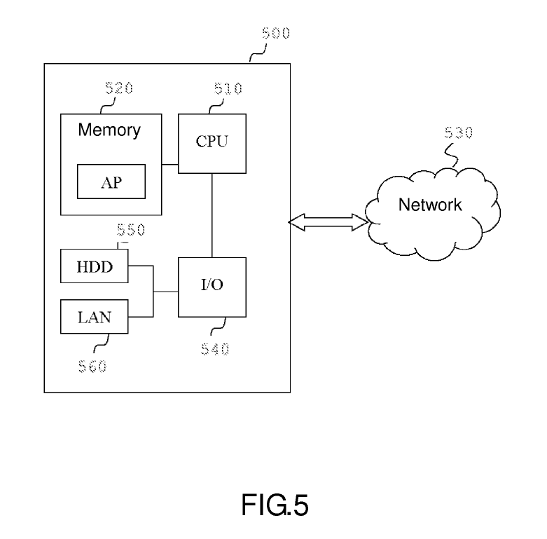

FIG. 5 further shows a hardware environment block diagram of a computer device 500, which may serve as the servers 110, 112, and 114 in FIG. 1.

In one embodiment, the computer device 500 has a processor to execute dedicated application programs; a storage device to save various information and program codes; a communication and input/output device to act as an interface for users to communicate with; and peripheral devices or other specific usage devices. Other embodiments may also be implemented with other forms and have more or less apparatuses or devices.

As shown in FIG. 5, the computer device 500 may have a processor 510, a memory 520, and an input/output (I/O) unit 540. The I/O bus may be a high-speed serial bus such as a PCI-e bus, yet other bus architectures may also be used. Other connections to the I/O bus may be connected directly to the devices or through expansion cards. The I/O unit 540 may also be coupled to a hard disk 550 or a local area network (LAN) adaptor 560. By the LAN adaptor 560, the computer device 500 may communicate with other computer devices through a network 530. The network 530 may be implemented with any type of connection including static LAN connections or wide area network (WAN) connections or dialup networking by Internet service providers; the connection scheme is also not limited and may include wired or wireless connections such as communications with user computers by wireless networks of GSM or Wi-Fi. However, it should be understood that other hardware and software components (such as additional computer systems, routers, firewalls, etc.) may be included in the network despite not being shown in the figures. The memory 520 may be a random access memory (RAM), a read-only memory (ROM), or an erasable programmable read-only memory (EPROM or Flash memory). The memory 520 is used to save an operating system, program codes of a dedicated main program AP, and all kinds of information. The operating system is executed on the processor 510 and coordinates and provides control of various devices in the computer device 500; the processor 510 may access the memory 520 to execute the main program AP.

Those skilled in the art may understand that the hardware of the computer device 500 in FIG. 5 may have various modifications according to different embodiments. Other internal hardware or peripheral devices such as Flash ROM, equivalent non-volatile memory, optical drive, etc. may be added to or replace the hardware shown in FIG. 5.

The present invention can be embodied in any other specific manners without departing from the spirit or essential features of the present invention. Every aspect of the aforesaid embodiments of the present invention must be deemed illustrative rather than restrictive of the present invention. Hence, the scope of the present invention is defined by the appended claims instead of the above description. All equivalent meanings and scope which fall within the appended claims must be deemed falling within the scope of the appended claims.

What is claimed is:

1. A computer implemented method for automatically determining game mechanics in business process gamification, the method comprising:
accessing, from a history database, execution data of prior users of a first task in a business process;
analyzing the execution data of the prior users of the first task; and
determining game mechanics for the first task according to a result of the analyzing.

2. The method as claimed in claim 1, wherein the execution data of the prior users is updated in real-time prior to the analyzing.

3. The method as claimed in claim 1, wherein the execution data of the prior users comprises time spent by the prior users to finish the first task.

4. The method as claimed in claim 1, wherein the determining comprises confirming whether a variance of the execution data of the prior users is within a predetermined range.

5. The method as claimed in claim 1, wherein the execution data of the prior users comprises counts of a predetermined operation executed by the prior users to finish the first task.

6. The method as claimed in claim 1, wherein the accessing comprises accessing the execution data of the prior users of a second task in the business process, and the analyzing comprises analyzing the execution data of the prior users of the second task.

7. The method as claimed in claim 1, wherein the determining comprises selecting a game element adopted by the game mechanics.

8. The method as claimed in claim 7, wherein the determining comprises determining a parameter of the game element.

9. The method as claimed in claim 8, wherein the analyzing comprises clustering the execution data of the prior users, wherein the parameter is based on a result of clustering.

10. A system comprising:
a memory having computer readable instructions; and
one or more processors for executing the computer readable instructions, the computer readable instructions comprising:
accessing, from a history database, execution data of prior users of a first task in a business process;
analyzing the execution data of the prior users of the first task; and
determining game mechanics for the first task according to a result of the analyzing.

11. The system as claimed in claim 10, wherein the execution data of the prior users is updated in real-time prior to the analyzing.

12. The system as claimed in claim 10, wherein the execution data of the prior users comprises time spent by the prior users to finish the first task.

13. The system as claimed in claim 10, wherein the determining comprises confirming whether a variance of the execution data of the prior users is within a predetermined range.

14. The system as claimed in claim 10, wherein the execution data of the prior users comprises counts of a predetermined operation executed by the prior users to finish the first task.

15. The system as claimed in claim 10, wherein the accessing comprises accessing the execution data of the prior users of a second task in the business process, and the analyzing comprises analyzing the execution data of the prior users of the second task.

16. The system as claimed in claim 10, wherein the determining comprises selecting a game element adopted by the game mechanics.

17. The system as claimed in claim 16, wherein the determining comprises determining a parameter of the game element.

18. The system as claimed in claim 17, wherein the analyzing comprises clustering the execution data of the prior users, wherein the parameter is based on a result of clustering.

19. A computer program product for automatically determining game mechanics in business process gamification, the computer program product comprising a computer readable storage medium having program instructions embodied therewith, the program instructions executable by a processor to cause the processor to:
access, from a history database, execution data of prior users of a first task in a business process;
analyze the execution data of the prior users of the first task; and
determine game mechanics for the first task according to a result of the analyzing.

20. The computer program product of claim 19, wherein the execution data of the prior users is updated in real-time prior to the analyzing.
